(19) United States
(12) Patent Application Publication
(10) Pub. No.: US 2014/0093078 A1
(43) Pub. Date: Apr. 3, 2014

(54) DYNAMIC LOSS PROTECTION

(71) Applicants: NELSON KIDD, Camas, WA (US); BRYAN Y. ROE, Camas, WA (US); WILLIAM J. LEWIS, North Plains, OR (US)

(72) Inventors: NELSON KIDD, Camas, WA (US); BRYAN Y. ROE, Camas, WA (US); WILLIAM J. LEWIS, North Plains, OR (US)

(21) Appl. No.: 13/630,441

(22) Filed: Sep. 28, 2012

(51) Int. Cl. H04W 12/02

(52) U.S. Cl. CPC H04W 12/02
USPC 380/270; 726/1

(57) ABSTRACT

A method comprises determining a number of radio sources within a region proximate an electronic device and adjusting one or more loss prevention policies based on the number of radio sources within the region proximate the electronic device. Other embodiments may be described.

### RELATED APPLICATIONS

### BACKGROUND

The subject matter described herein relates generally to the field of electronic devices and more particularly to loss protection in electronic devices.

Some electronic devices may be susceptible to loss due to theft of the electronic device. This problem may be exacerbated hen a user of a mobile device takes the mobile device into an area which is relatively crowded such as, for example, an airport waiting area.

In some instances the data resident on the device is confidential, and may be far more valuable than the electronic device. Accordingly techniques to safeguard the electronic device and/or data in the event, that an electronic device is stolen or is subject to an unauthorized access by a user may find utility.

### BRIEF DESCRIPTION OF THE DRAWINGS

The detailed description is described with reference to the accompanying figures.

FIG. 1 is a schematic illustration of an exemplary electronic device which may be adapted to implement dynamic loss protection in accordance with sonic embodiments.

FIG. 2 is a schematic illustration of an exemplary networking environment in which an electronic device may be adapted to implement dynamic data protection in accordance with some embodiments.

FIG. 3 is a schematic illustration of a wireless networking access point device in a wireless networking environment in which dynamic data protection may he implemented in accordance with some embodiments.

FIGS. 4-5 are flowcharts illustrating operations in method to implement dynamic loss protection in an electronic device, in accordance with some embodiments.

FIG. 6 is a schematic illustration of a system which may be adapted to implement data protection, according to an embodiment.

### DETAILED DESCRIPTION

Described herein are exemplary systems and methods for to implement dynamic loss protection in electronic devices. In the following description, numerous specific details are set forth to provide a thorough understanding of various embodiments. However, it will be understood by those skilled in the art that the at embodiments may be practiced without the specific details. In other instances, well-known methods, procedures, components, and circuits have not been illustrated or described in detail so as not to obscure the particular embodiments.

A crowded area presents greater risk for loss of an electronic device. Thus, in some situations it may be useful to change loss protection policies for an electronic device in response to the degree to which an area may be characterized as being crowded, e.g., by enforcing stricter loss protection policies in relatively crowded areas. In some embodiments an electronic device may be adapted to monitor radio sources (e.g., wireless access points, bluetooth devices, hotspots, etc.) in a geographic area proximate the electronic device, collect statistics relating to numbers of radio sources, and to set one or more loss prevention policies based on the statistics, thereby using a number of radio sources as a proxy for crowd measurement. This enables an electronic device to alter loss prevention policies automatically and in real time in response to perceived changes in the surrounding environment.

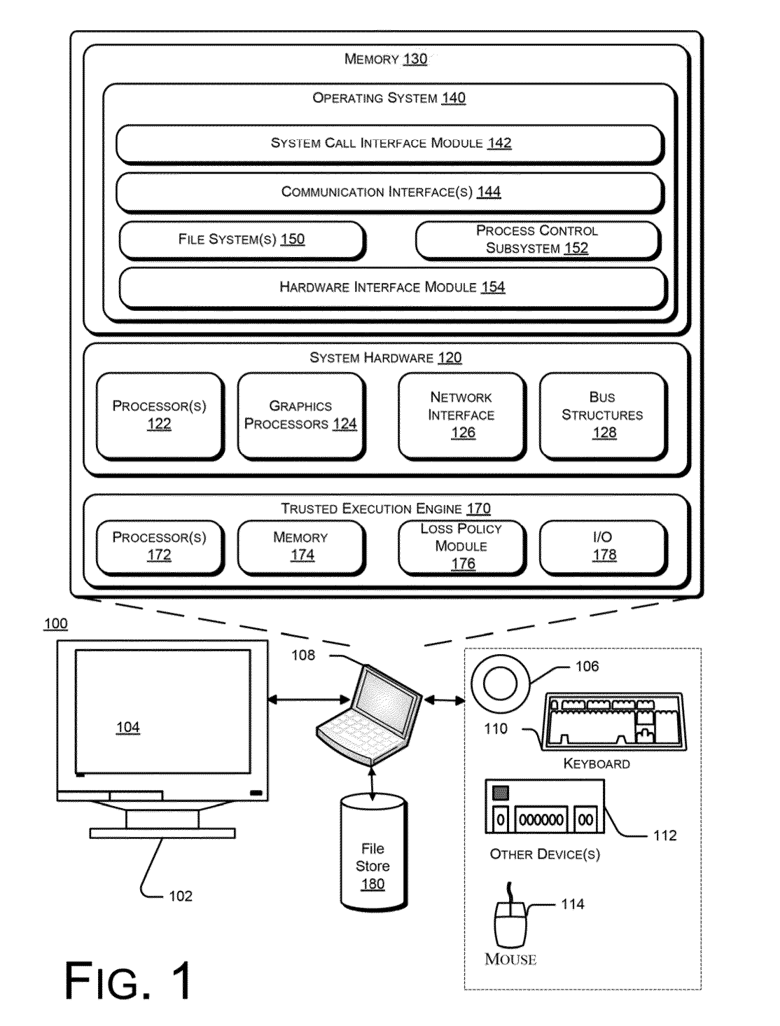

FIG. 1 is a schematic illustration of an exemplary system 100 which may be adapted to implement dynamic loss protection in accordance with some embodiments. In one embodiment, system 100 includes an electronic device 108 and one or more accompanying input/output devices including a display 102 having a screen 104, one or more speakers 106, a keyboard 110, one or more other I/O device(s) 112, and a mouse 114. The other I/O device(s) 112 may include a touch screen, a voice-activated input device, a track ball, a geolocation device, an accelerometer/gyroscope, biometric feature input devices, and any other device that allows the system 100 to receive input from a user.

In various embodiments, the electronic device 108 may be embodied as a personal computer, a laptop computer, a personal digital assistant, a mobile telephone, an entertainment device, or another computing device. The electronic device 108 includes system hardware 120 and memory 130, which may be implemented as random access memory and/or read-only memory. A file store 180 may be communicatively coupled to computing device 108. File store 180 may be internal to computing, device 108 such as one or more hard drives, CD-ROM drives, DVD-ROM drives, or other types of storage devices. File store 180 may also be external to computer 108 such as, e.g., one or more external hard drives, network attached storage, or a separate storage network.

System hardware 120 may include one or more processors 122, graphics processors 124, network interfaces 126, and bus structures 128. In one embodiment, processor 122 may be embodied as an Intel® Core2 Duo® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 124 may function as adjunct processor that manages graphics and/or video operations. Graphics processor(s) 124 may be integrated onto the motherboard of computing system 100 or may be coupled via an expansion slot on the motherboard.

In one embodiment, network interface 126 could be a wired interface such as an Ethernet interface (see, e.g., Institute of Electrical and. Electronics Engineers/IEEE 8023-2002) or a wireless interface such as an IEEE 802.11a, b or g-compliant interface (see, e.g., IEEE Standard for IT-Telecommunications and information exchange between systems LAN/MAN-Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

Memory 130 may include an operating system 140 for managing operations of computing device 108. In one embodiment, operating system 140 includes a hardware interface module 154 that provides an interface to system hardware 120. In addition, operating system 140 may include a file system 150 that manages files used in the operation of computing device 108 and a process control subsystem 152 that manages processes executing on computing device 108.

Operating system 140 may include (or manage) one or more communication interfaces that may operate in conjunction with system hardware 120 to transceive data packets and/or data streams from a remote source. Operating system 140 may further include a system call interface module 142 that provides an interface between the operating system 1.40 and one or more application modules resident in memory 130. Operating system 140 may be embodied as a UNIX operating system or any derivative thereof (e.g., Linux, Solaris, etc.) or as a Windows® brand operating system, or other operating systems.

In sonic embodiments system 100 may comprise a low-power embedded processor, referred to herein, as a trusted execution engine 170. The trusted execution engine 170 may be implemented as an independent integrated circuit located on the motherboard of the system 100. In the embodiment depicted in FIG. 1 the trusted execution engine 170 comprises a processor 172, a memory module 174, loss policy module 176 and an I/O module 178. In some embodiments the memory module 174 may comprise a persistent flash memory module and the loss policy module 176 may be implemented as logic instructions encoded in the persistent memory module, e.g., firmware or software. The I/O module 178 may comprise a serial I/O module or a parallel 110 module. Because the trusted execution engine 170 is physically separate from the main processor(s) 122 and operating system 140, the trusted execution engine 170 may be made secure, i.e., inaccessible to hackers such that it cannot be tampered with.

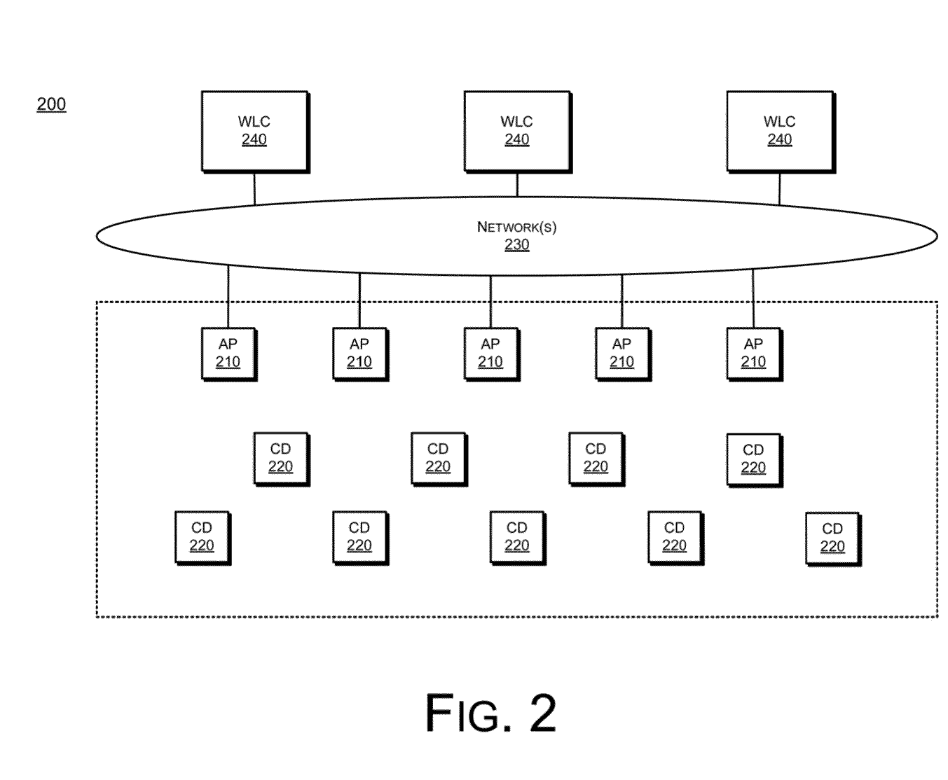

FIG. 2 is a schematic illustration of a wireless communication networking environment in which dynamic loss protection may be implemented, according to embodiments. Referring to FIG. 2, in brief overview in one embodiment a wireless networking environment 200 may comprise a plurality of access point (AP) devices 210 coupled to one or more networks 230. Each AP device 210 may provide wireless network access to one or more wireless client devices (CDs) 220 that operate in the WLAN environment 100. The client, devices 220 may he embodied as an electronic device 100 as depicted m FIG. 1, e.g., a laptop computer, a tablet computer, a mobile phone, an electronic reader, or the like.

WLAN controllers 240 are coupled to the network(s) 230. The controllers 240 manage one or more AP devices 210, e.g., by assigning a transmission channel to each AP device in its group. In general, each AP device may be assigned to operate on a different channel. Wireless communication by devices in the WLAN may take place made in one or more frequency bands, e.g., unlicensed frequency bands, such as in the 2.4 GHz and in the 5 GHz unlicensed bands in the United States. Each frequency band may comprise multiple communication channels. There are many factors that may affect the performance of an AP device 210 in a wireless network. Examples of such factors include RF interference occurring in any channel from wireless devices that are part of another WLAN and RF energy from devices that are not WLAN devices (e.g., Bluetooth devices, microwave ovens, digital cordless telephones, etc.). In addition, an AP device 210 in the environment 200 may contend for use of a channel with another AP device 210 in the environment.

In operation, at the time of initial deployment of the wireless environment 200 and then on a periodic or)n-demand basis thereafter, the controllers 240 may perform a dynamic channel assignment (DCA) process whereby channels for AP devices 210 are assigned based on various factors. Thus, after the initial deployment of the WLAN environment 200 is made, the AP devices 210 may monitor the RF environments and supply data representing the quality of their respective RF environments to a corresponding plurality of WI AN controllers 240.

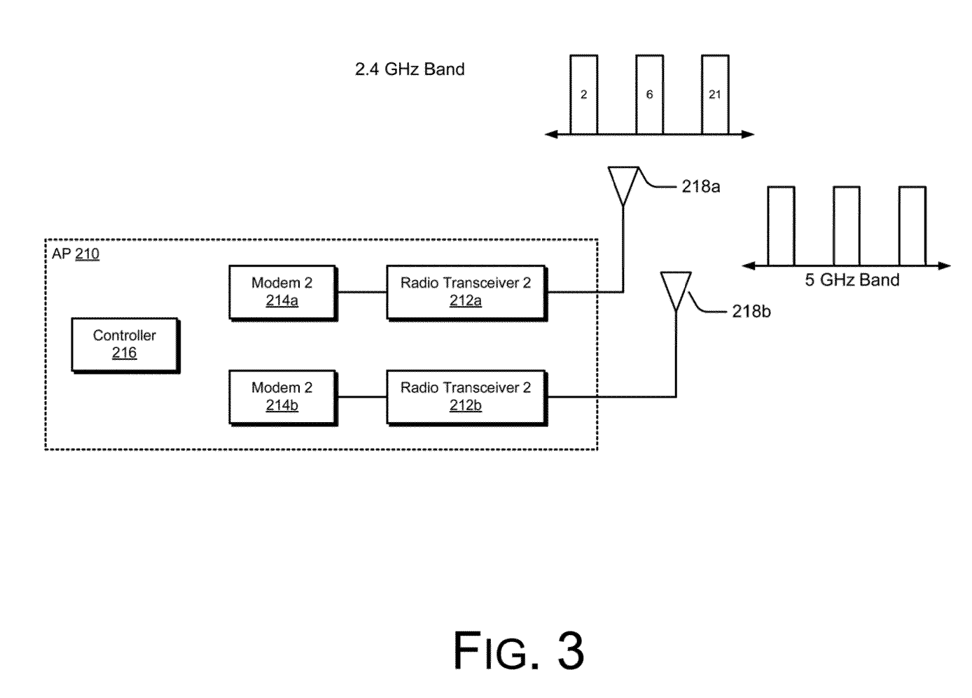

FIG. 3 is a schematic illustration of a wireless networking access point device in a wireless networking environment in which dynamic data protection may be implemented in accordance with some embodiments. Turning now to FIG. 3, an AP device 210 represents the block diagram of any AP device 210 shown in FIG. 1. In some embodiments the AP device 210 may be configured to serve wireless communication simultaneously in two or more different bands, e.g., the 2.4 GHz band and the 5 GHz band. To this end, the AP device 21˜comprises a first radio transceiver 212a and a corresponding modem 214a. The first radio transceiver 212a transmits and receives RF signals via antenna 218a. Similarly, there is a second radio transceiver 212b and a corresponding modem 214b, and the second radio transceiver 212b transmits and receives signals via antenna 218b.

By way of example, the radio transceiver 212a and modem 214a may be part of a WLAN chipset that is configured to serve wireless communication on channels in the 2.4 GHz band and the radio transceiver 212b and modem 214b may be part of a WLAN chipset that is configured to serve wireless communication on channels in the 5 GHz band. A controller 216 controls the two communication channel components in the AP device 210. For example, the controller 21 may be implemented a microprocessor, digital signal processor, application specific integrated circuit (ASIC) (comprising programmable or fixed digital logic gates) that is configured to perform a variety of control functions. In addition, the controller 216 may be configured to control the radio transceivers 212a and 212b and modems 214a and 214b to capture data from these components in order to compute data related to the “air quality” factors for each communication channel shown in FIG. 3.

When reference is made herein to it communication channel of an AP device, it is to be understood that this refers to a channel used by one of possible several radio transceivers in an AP device since an AP device may have multi-band service capability as depicted in FIG. 3 Thus, an AP device may be assigned different channels (in different frequency bands) for each of its different band specific radio transceivers.

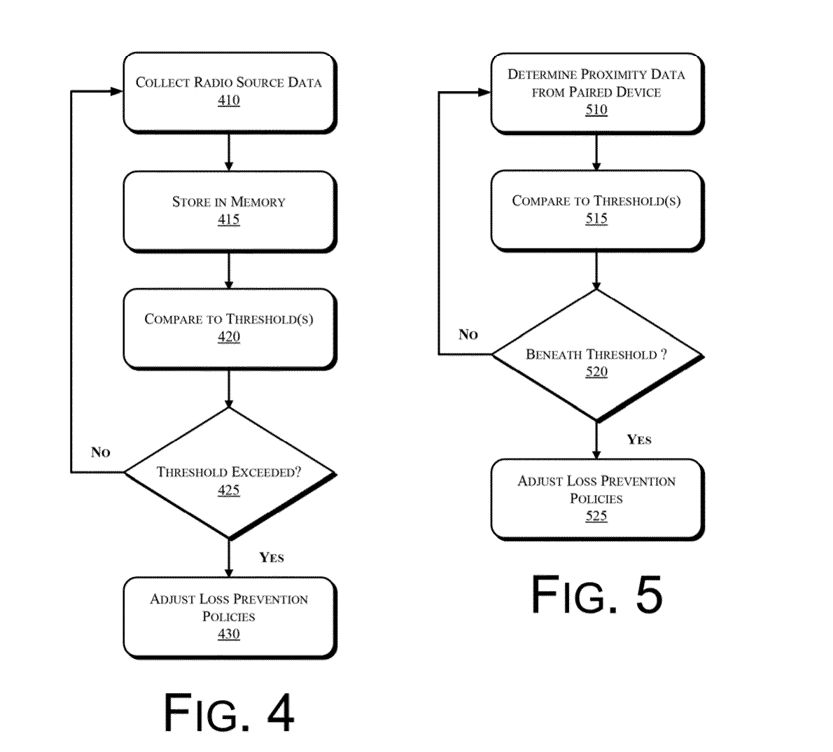

In some embodiments an electronic device 100 may be adapted to implement dynamic loss protection procedures. FIG. 4 is a flowchart illustrating operations in a method to implement dynamic loss protection in an electronic device, in accordance with some embodiments. Operations for implementing dynamic loss protection service are described with reference to FIG. 4. In some embodiments the operations depicted in FIG. 4 may be implemented by the loss policy module 176, alone or in combination with other components of the electronic device. In other embodiments the operations depicted in FIG. 4 may be implemented by processor 122 or by a processor integrated with or coupled to a network interface, such as a network interface card.

Referring to FIG. 4, at operation 410 the loss policy module 176 in the electronic device 100 collects radio source data within a region proximate the electronic device 100. By way of example, in a network-based embodiment as depicted in FIG. 2, an electronic device 100 may detect one or more wi-fi access points 210 or client devices 220 in a region, or one or more ad-hoc communication devices such as Bluetooth devices, hotspots, or the like.

At operation 415 the radio source data be stored in a memory module, e.g., the memory module 174 in the trusted execution engine 170. In some embodiments radio source data may be stored over time to construct a data repository of radio source data in a region proximate the electronic device.

At operation 420 the radio source data collected in operation 410 may be compared to one or more thresholds. In some embodiments the threshold(s) may be derived by processing the historical radio source data stored in the memory module 174 of electronic device. By way of example, the radio source data may be segmented into two or more categories which characterize the degree to which the number of radio sources in the region represent a crowded region. The segmentation may be a simple two-category (crowded/uncrowded) division or may include multiple categories representative of degrees of crowding. In some embodiments the loss policy module 176 may generate a population density indicator based on the number of radio sources detected and may display the population density indicator on a display of the electronic device.

If at operation 425 the radio source data collected in operation 410 does not exceed a threshold, then control passes back to operation 410 and the loss policy module 176 continues to monitor radio source data in the region proximate the electronic device 100.

By contrast, if at operation 425 the radio source data collected in operation 410 exceeds a threshold, then control passes to operation 430 and the loss policy module 176 adjusts one or more loss prevention policies based on the number of radio sources within the region proximate the electronic device 100. By way of example, in some embodiments the loss policy module 176 may reduce the time period of inactivity required to force the electronic device 100 into a sleep state or a hibernate state, to disable one or more access ports or network connections, or to force a login procedure. In other embodiments the loss policy module 176 may encrypt critical data stored on the electronic device until such time when a login procedure is successful.

In some embodiments the loss policy module 176 may implement a procedure which relies on a proximity measure between the electronic device 100 and a paired electronic device to determine whether to implement additional loss prevention policies. By way of example, users may carry a cell phone or other electronic device on their body. Thus, the loss policy module 176 may use a proximity measure between a cell phone and other electronic device as an indicator of a distance between the user and the electronic device 100.

Operations in one such procedure are depicted in FIG. 5. At operation 510 the loss policy module 176 collects proximity data from a paired device. By way of example, a user may pair a cell phone or other portable device with electronic device 100. In some embodiments electronic device 100 may determine a signal strength indicator such as a received signal strength indicator (RSSI), or Link Quality (LQ) as a surrogate for a proximity measure.

At operation 515 the signal strength indicator may be compared to one or more thresholds. By way of example, a threshold for the signal strength may be set which indicates that he electronic device 100 and the paired device are in close physical proximity. If, at operation 520, the signal strength is not beneath the threshold then the devices may be considered physically proximate. Accordingly, control passes back to operation 510 and the loss policy module continues to determine proximity data from the paired device.

By contrast, if at operation 520 the signal strength is beneath the threshold then control passes to operation 525 and the loss policy module 176 adjusts one or more loss prevention policies in a manner similar to that described with reference to operation 430. In sonic embodiments a linear regression slope of the signals may be used as a form of a threshold. For example, the slope of the signal strength trend line may be measured to determine if the paired device is coming closer or moving farther away. The slope required may vary as a function of population density.

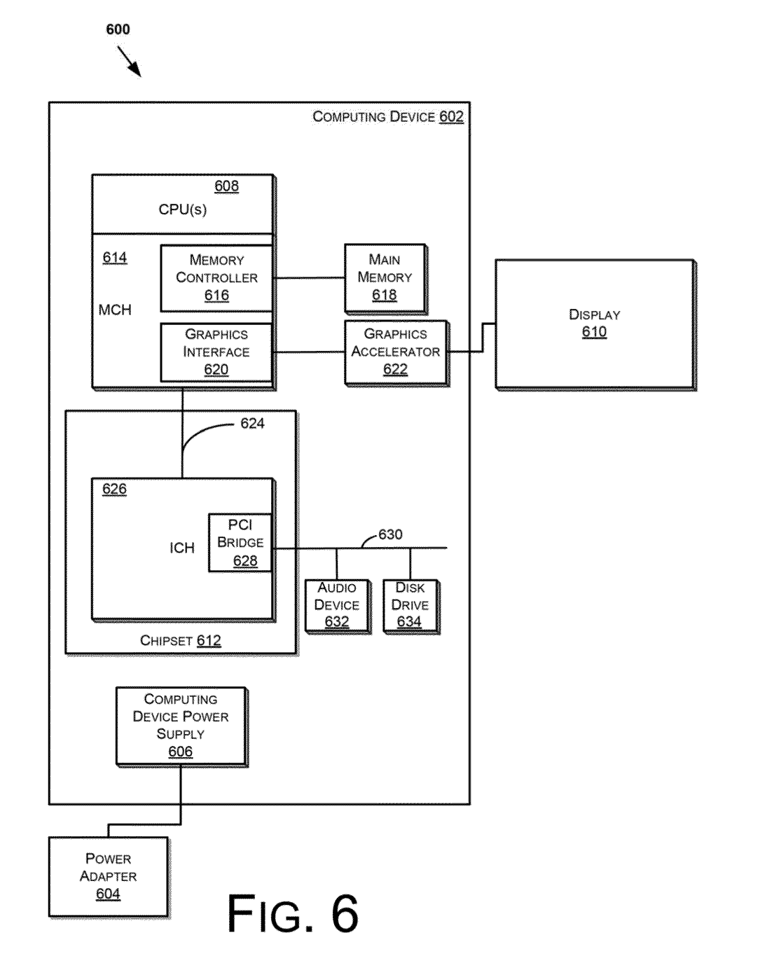

As described above, in some embodiments the electronic device may be embodied as a computer system. FIG. 6 is a schematic illustration of a computer system 600 in accordance with some embodiments. The computer system 600 includes a computing device 602 and a power adapter 604 (e.g., to supply electrical power to the computing device 602). The computing device 602 may be any suitable computing device such as a laptop (or notebook) computer, a personal digital assistant, a desktop computing device a workstation or a desktop computer), a rack-mounted computing device, and the like.

Electrical power may he provided to various components of the computing device 602 (e.g., through a computing device power supply 606) from one or more of the following sources: one or more battery packs, an alternating current (AC) outlet (e.g., through a transformer and/or adaptor such as a power adapter 604), automotive power supplies, airplane power supplies, and the like. In some embodiments, the power adapter 604 may transform the power supply source output (e.g., the AC outlet voltage of about 110 VAC to 240 VAC) to a direct current (DC) voltage ranging between about 7 VDC to 12.6 VDC. Accordingly, the power adapter 604 may be an AC/DC adapter.

The computing device 602 may also include one or more central processing unit(s) (CPUs) 608. In some embodiments, the CPU 608 may he one or more processors in the Pentium® family of processors including the Pentium® II processor family, Pentium® III processors. Pentium® IV, or CORE2 Duo processors available from Intel® Corporation of Santa Clara, Calif. Alternatively, other CPUs may be used such as Intel's Itanium®, XEON□, and Celeron® processors. Also, one or more processors from other manufactures may be utilized. Moreover, the processors may have a single or multi core design.

A chipset 612 may be coupled to, or integrated with, CPU 608. The chipset 612 may include a memory control hub (MCH) 614. The MCH 614 may include a memory controller 616 that is coupled to a main system memory 618. The main system memory 618 stores data and sequences of instructions that are executed by the CPU 608, or any other device included in the system 600. In some embodiments, the main system memory 618 includes random access memory (RAM); however, the main system memory 618 may be implemented using other memory types such as dynamic RAM (DRAM), synchronous DRAM (SDRAM), and the like. Additional devices may also be coupled to the bus 610 such as multiple CPUs and/or multiple system memories.

The MCH 614 may also include a graphics interface 620 coupled to a graphics accelerator 622. In some embodiments, the graphics interface 620 is coupled to the graphics accelerator 622 via an accelerated graphics port (AGP). In some embodiments, a display (such as a flat panel display) 640 may be coupled to the graphics interface 620 through, for example, a signal converter that translates a digital representation of an image stored in a storage device such as video memory or system memory into display signals that are interpreted and displayed by the display. The display 640 signals produced by the display device may pass through various control devices before being interpreted by and subsequently displayed on the display.

A hub interface 624 couples the MCH 614 to an platform control hub (PCH) 626. The PCH 626 provides an interface to input/output (I/O) devices coupled to the computer system 600. The PCH 626 may be coupled to a peripheral component interconnect (PCI) bus. Hence, the PCH 626 includes a PCI bridge 628 that provides an interface to a PCI bus 630. The PCI bridge 628 provides a data path between the CPU 608 and peripheral devices. Additionally, other types of I/O interconnect topologies may be utilized such as the PCI Express□ architecture, available through Intel® Corporation of Santa Clara, Calif.

The PCI bus 630 may he coupled to an audio device 632 and one or more disk drive(s) 634. Other devices may be coupled to the PCI bus 630. In addition, the CPU 608 and the MCH 614 may be combined to form a single chip. Furthermore, the graphics accelerator 622 may be included within the MCH 614 in other embodiments.

Additionally, other peripherals coupled to the PCH 626 may include, in various embodiments, integrated drive electronics (IDE) or small computer system interface (SCSI) hard drive(s), universal serial bus (USB) port(s), a keyboard, as mouse, parallel port(s), serial port(s), floppy disk drive(s), digital output support (e.g., digital video interface (DVI)), and the like. Hence, the computing device 602 may include volatile and/or nonvolatile memory.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions store in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e,g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other but yet may still cooperate or interact with each other.

Reference in the specification to “one embodiment” or “some embodiments” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. A method to implement a loss prevention policy in an electronic device, comprising:
determining, in the electronic device, a number of radio sources within a region proximate the electronic device;
storing the number of radio sources in a memory of the electronic device;
comparing the number of radio sources to one or more thresholds determined from historical radio source data in the memory of the electronic device;
generating a population density indicator based on the number of radio sources; and
adjusting, in the electronic device, one or more loss prevention policies for the electronic device based on the number of radio sources within the region proximate the electronic device.

2. The method of claim 1, wherein determining a number of radio sources within a region proximate an electronic device comprises detecting at least one of:
wireless network access points proximate the electronic device;
wireless network client devices proximate the electronic device; or
Bluetooth radio sources proximate the electronic device.

3. The method of claim 1, further comprising:
presenting the population density indicator on a display of the electronic device.

4. The method of claim 1, wherein adjusting one or more loss prevention policies based on the number of radio sources within the region proximate the electronic device comprises:
determining a distance parameter between the electronic device and a second electronic device; and
implementing a data protection policy when the distance parameter exceeds a threshold.

5. The method of claim 4, wherein implementing a data protection policy comprises at least one of:
forcing the electronic device into a sleep state or a hibernate state;
disabling one or more access ports;
disabling one or more network connections;
forcing a login procedure;
encrypting data stored on the electronic device; or
decrypting data stored on the electronic device when the login procedure is successful.

6. The method of claim 4, wherein the threshold is set dynamically in response to changes in the number of radio sources.

7. A computer program product comprising logic instructions stored on a non-transitory computer readable medium which, when executed by a processor in an electronic device, configure the processor to perform operations, comprising:
determining, in an electronic device, a number of radio sources within a region proximate the electronic device;
storing the number of radio sources in a memory of the electronic device;
comparing the number of radio sources to one or more thresholds determined from historical radio source data in the memory of the electronic device;
generating a population density indicator based on the number of radio sources; and
adjusting, in the electronic device, one or more loss prevention policies for the electronic device based on the number of radio sources within the region proximate the electronic device.

8. The computer program product of claim 7, wherein determining a number of radio sources within a region proximate an electronic device comprises detecting at least one of:
wireless network access points proximate the electronic device;
wireless network client devices proximate the electronic device; or
Bluetooth radio sources proximate the electronic device.

9. The computer program product of claim 7, further comprising logic instructions stored on a non-transitory computer readable medium which, when executed by a processor in an electronic device, configure the processor to perform operations, comprising:
presenting the population density indicator on a display of the electronic device.

10. The computer program product of claim 7, wherein adjusting one or more loss prevention policies based on the number of radio sources within the region proximate the electronic device comprises:
determining a distance parameter between the electronic device and a second electronic device; and
implementing a data protection policy when the distance parameter exceeds a threshold.

11. The computer program product of claim 10, wherein implementing a data protection policy comprises at least one of:
forcing the electronic device into a sleep state or a hibernate state;
disabling one or more access ports;
disabling one or more network connections;
forcing a login procedure;
encrypting data stored on the electronic device; or
decrypting data stored on the electronic device when the login procedure is successful.

12. The computer program product of claim 10, wherein the threshold is set dynamically in response to changes in the number of radio sources.

13. An electronic device, comprising:
a processor; and
a non-transitory memory comprising logic instructions which, when executed by the processor, configure the processor to perform operations, comprising:
determining, in the electronic device, a number of radio sources within a region proximate the electronic device;
storing the number of radio sources in a memory of the electronic device;
comparing the number of radio sources to one or more thresholds determined from historical radio source data in the memory of the electronic device;
generating a population density indicator based on the number of radio sources; and
adjusting, in the electronic device, one or more loss prevention policies for the electronic device based on the number of radio sources within the region proximate the electronic device.

14. The electronic device of claim 13, wherein determining a number of radio sources within a region proximate an electronic device comprises detecting at least one of:
wireless network access points proximate the electronic device;
wireless network client devices proximate the electronic device; or
Bluetooth radio sources proximate the electronic device.

15. The electronic device of claim 13, further comprising logic instructions which, when executed by the processor, configure the processor to perform operations, comprising:
presenting the population density indicator on a display of the electronic device.

16. The electronic device of claim 13, wherein adjusting one or more loss prevention policies based on the number of radio sources within the region proximate the electronic device comprises:
determining a distance parameter between the electronic device and a second electronic device; and
implementing a data protection policy when the distance parameter exceeds a threshold.

17. The electronic device of claim 16, wherein implementing a data protection policy comprises at least one of:
forcing the electronic device into a sleep state or a hibernate state;
disabling one or more access ports;
disabling one or more network connections;
forcing a login procedure;
encrypting data stored on the electronic device; or
decrypting data stored on the electronic device when the login procedure is successful.

18. The electronic device of claim 16, wherein the threshold is set dynamically in response to changes in the number of radio sources.

19. A controller comprising logic circuitry to:
determine, in an electronic device, a number of radio sources within a region proximate the electronic device;
store the number of radio sources in a memory of the electronic device;
compare the number of radio sources to one or more thresholds determined from historical radio source data in the memory of the electronic device;
generate a population density indicator based on the number of radio sources; and
adjust, in the electronic device, one or more loss prevention policies for the electronic device based on the number of radio sources within the region proximate the electronic device.

20. The controller of claim 19, further comprising logic circuitry to detect at least one of:
wireless network access points proximate the electronic device;
wireless network client devices proximate the electronic device; or
Bluetooth radio sources proximate the electronic device

21. The controller of claim 19, further comprising logic circuitry to:
present the population density indicator on a display of the electronic device.

22. The controller of claim 19, further comprising logic circuitry to:
determine a distance parameter between the electronic device and a second electronic device; and
implement a data protection policy when the distance parameter exceeds a threshold.

23. The controller of claim 19, further comprising logic circuitry to:
force the electronic device into a sleep state or a hibernate state;
disable one or more access ports;
disable one or more network connections;
force a login procedure;
encrypt data stored on the electronic device; or
decrypt data stored on the electronic device when the login procedure is successful.

24. The controller of claim 22, wherein the threshold is set dynamically in response to changes in the number of radio sources.
